(19) United States
(12) Patent Application Publication
(10) Pub. No.: US 2018/0060503 A1
(43) Pub. Date: Mar. 1, 2018

(54) Targeted Adjustment of Previous Insights Based on Changes to Positional Statements

(71) Applicant: International Business Machines Corporation, Armonk, NY (US)

(72) Inventor: Corville O. Allen, Morrisville, NC (US)

(21) Appl. No.: 15/245,260

(22) Filed: Aug. 24, 2016

(51) Int. Cl. G06F 19/00

(52) U.S. Cl. CPC G06F 19/325; G06F 19/322; G06F 19/363; G06F 19/345

(57) ABSTRACT

Mechanisms are provided that ingest a corpus of content which includes a plurality of guideline documents having one or more positional statements. The mechanisms generate a set of insight data structures based on the ingested corpus, which are mapped to corresponding positional statements or guidelines in the content of the corpus from which the insight data structures were generated. The mechanisms receive a modification to a positional statement or guideline in the corpus and determine an insight data structure affected by the modification to the positional statement or guideline based on the set of insight data structures and the mapping to corresponding positional statements or guidelines. The mechanisms update the affected insight data structure, without re-ingesting the entire corpus, to generate an updated set of insight data structures, and perform a cognitive operation based on the updated set of insight data structures.

### BACKGROUND

The present application relates generally to an improved data processing apparatus and method and more specifically to mechanisms for providing targeted adjustment of previous insights based on changes to positional statements. Decision-support systems exist in many different industries where human experts require assistance in retrieving and analyzing information. An example that will be used throughout this application is a diagnosis system employed in the healthcare industry. Diagnosis systems can be classified into systems that use structured knowledge, systems that use unstructured knowledge, and systems that use clinical decision formulas, rules, trees, or algorithms. The earliest diagnosis systems used structured knowledge or classical, manually constructed knowledge bases. The Internist-I system developed in the 1970s uses disease-finding relations and disease-disease relations. The MYCIN system for diagnosing infectious diseases, also developed in the 1970s, uses structured knowledge in the form of production rules, stating that if certain facts are true, then one can conclude certain other facts with a given certainty factor. DXplain, developed starting in the 1980s, uses structured knowledge similar to that of Internist-I, but adds a hierarchical lexicon of findings.

Iliad, developed starting in the 1990s, adds more sophisticated probabilistic reasoning where each disease has an associated a priori probability of the disease (in the population for which Iliad was designed), and a list of findings along with the fraction of patients with the disease who have the finding (sensitivity), and the fraction of patients without the disease who have the finding (1−specificity).

In 2000, diagnosis systems using unstructured knowledge started to appear. These systems use some structuring of knowledge such as, for example, entities such as findings and disorders being tagged in documents to facilitate retrieval. ISABEL, for example, uses Autonomy information retrieval software and a database of medical textbooks to retrieve appropriate diagnoses given input findings. Autonomy Auminence uses the Autonomy technology to retrieve diagnoses given findings and organizes the diagnoses by body system. First CONSULT allows one to search a large collection of medical books, journals, and guidelines by chief complaints and age group to arrive at possible diagnoses. PEPID DDX is a diagnosis generator based on PEPID's independent clinical content.

Clinical decision rules have been developed for a number of medical disorders, and computer systems have been developed to help practitioners and patients apply these rules. The Acute Cardiac Ischemia Time-Insensitive Predictive Instrument (ACI-TIPI) takes clinical and ECG features as input and produces probability of acute cardiac ischemia as output to assist with triage of patients with chest pain or other symptoms suggestive of acute cardiac ischemia. ACI-TIPI is incorporated into many commercial heart monitors/defibrillators. The CaseWalker system uses a four-item questionnaire to diagnose major depressive disorder. The PKC Advisor provides guidance on 98 patient problems such as abdominal pain and vomiting.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising at least one processor and at least one memory, the at least one memory comprising instructions executed by the at least one processor to cause the at least one processor to implement a cognitive system. The method comprises ingesting, by the cognitive system, a corpus of content that includes a plurality of guideline documents having one or more positional statements. The method also comprises generating, by the cognitive system, a set of insight data structures based on the ingested corpus. The set of insight data structures are mapped to corresponding positional statements or guidelines in the content of the corpus from which the insight data structures were generated. In addition, the method comprises receiving, by the cognitive system, a modification to a positional statement or guideline in the corpus and determining, by the cognitive system, an insight data structure affected by the modification to the positional statement or guideline based on the set of insight data structures and the mapping to corresponding positional statements or guidelines. The method also comprises updating, by the cognitive system, the affected insight data structure, without re-ingesting the entire corpus, to generate an updated set of insight data structures, and performing, by the cognitive system, a cognitive operation based on the updated set of insight data structures.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive healthcare system in a computer network;

FIG. 2 is a block diagram of an example data processing system in which aspects of the illustrative embodiments are implemented;

FIG. 3 is an example diagram illustrating an interaction of elements of a healthcare cognitive system in accordance with one illustrative embodiment;

FIG. 4 illustrates a cognitive healthcare system implementing a Question and Answer (QA) or request processing pipeline for processing an input question or request in accordance with one illustrative embodiment; and

FIG. 5 is a flowchart outlining an example operation for performing an update to an insight data structure based on a change to a positional statement in accordance with one illustrative embodiment.

### DETAILED DESCRIPTION

Cognitive natural language processing systems ingest large corpora of documentation to generate annotations and data structures representing the identified features within the various documents. This process is a time consuming process and requires a large amount of resources to complete. In the case of medical treatment guidelines, the positional statements within these medical treatment guidelines are processed to generate insight data structures that represent the knowledge of treatments, when they are applicable, and the manner by which such treatments are to be provided to patients. These medical treatment guidelines and/or positional statements within these medical treatment guidelines are updated on a periodic basis, e.g., monthly, quarterly, annually, etc. In many cases, government agencies, such as the U.S. Food and Drug Administration (FDA), adjust these guidelines and/or positional statements on a routine basis.

A medical guideline is the text found in a guideline document without any clear indication that it is a positional statement based on studies by the organization, for example “In addition to the A1C test, the FPG and 2-h PG may also be used to diagnose diabetes”. The American Diabetes Association, for example, indicates positional statements on a scale from A through E. A positional statement example may be “To test for prediabetes, the A1C, FPG, and 2-h PG after 75-g OGTT are appropriate. B”. The “B” following the statement, or indicated with the statement, gives the statement a positional statement value of B, which implies supportive evidence from well conducted cohort studies allows the ADA to make these statements with confidence.

In order to ensure the most up-to-date information is being used by medical treatment recommendation systems, when changes to a corpus of document, such as medical guidelines and/or positional statements within medical guidelines, the corpus must be re-ingested, requiring the expenditure of a large amount of time and resources to rebuild the insights using the modified corpus. However, many of the insights will not be changed by the relatively small number of changes to the corpus, i.e. a relatively small number of the positional statements or guidelines may occur, yet the entire corpus must be re-ingested to account for these changes. For example, if a positional statement in a medical treatment guideline changes the age range of the patient for which the medical treatment is applicable, while this may affect the knowledge of when that particular medical treatment is applicable, it may not have any effect on other medical treatment guideline knowledge previously obtained through a previous ingestion process. Having to re-ingest the entire corpus again based on this single change results in a relatively large expenditure of resources for a relatively small change in extracted knowledge.

The illustrative embodiments herein provide mechanisms for targeting changes to insights based on the identified changes to the positional statements or guidelines and thereby avoid having to re-ingest the entire corpus whenever there is a change to a guideline or positional statement. The illustrative embodiments identify the current ingested positional statements corresponding to the modified positional statements and performs statement similarity analysis to identify the changes being implemented. The set of terms or phrases that have changed are then analyzed to identify the type of adjustment being made and what corresponding type of adjustment should be applied to the insights. In this way, the re-ingesting of the corpus or corpora as a whole is avoided and instead targeted updating of insights is performed based on already ingested insights and the identified changes in positional statements or guidelines.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms for performing targeted ingestion of changes to portions of a corpus of documents rather than having to re-ingest the entire corpus or corpora each time an update or set of updates are performed to the corpus or corpora. In some illustrative embodiments, the mechanisms operate on medical documentation, and in particular positional statements within medical guideline documents, that indicate the position taken with regard to treatment of particular medical conditions. For example, a positional statement may say that “female patients over age 40 that are diagnosed with type 2 diabetes, and which have a history of high blood pressure, should be given treatment X” where “treatment X” is a particular treatment determined to be helpful for managing the patient's medical condition of type 2 diabetes. At a later time, this positional statement may be updated based on new knowledge obtained or refined knowledge to indicate that female patients over age 35 that are diagnosed with type 2 diabetes, and which have a history of high blood pressure, should be given treatment X. Under current mechanisms, the entire corpus in which this changed positional statement is present must be re-ingested in order to implement new insights based on the changed positional statement. However, with the mechanisms of the illustrative embodiments, targeted re-ingestion of the portion of the corpus corresponding to the changed or updated positional statement is performed such that only the effect on the previously generated insights from the previous version of the positional statement are updated without having to re-ingest the entire corpus or corpora.

One of the key benefits of the illustrative embodiments is the absorption of document updates that occur relatively frequently in a corpus and being able to dynamically update the insights obtained from the updated documents of the corpus without having to expend large amounts of time and resources to perform re-ingestion of the corpus or corpora. For example, the U.S Food and Drug Administration (FDA) bulletins, yearly or quarterly updates of guidelines and drug label inserts, and the like, can be easily ingested and appropriate previously generated knowledge representations, or insights, represented in insight data structures utilized by cognitive systems, may be updated in a targeted manner such that the changes to the corpus may be reflected in these knowledge representations with minimal resource expenditures. This, in turn, affects the operation of the cognitive system which relies upon these knowledge representations to perform various evaluations, such as confidence scoring of candidate answers or treatment recommendations, application of rules to content of the corpus or corpora, and the like. That is, the cognitive system is presented with the most up-to-date information for performing its operations.

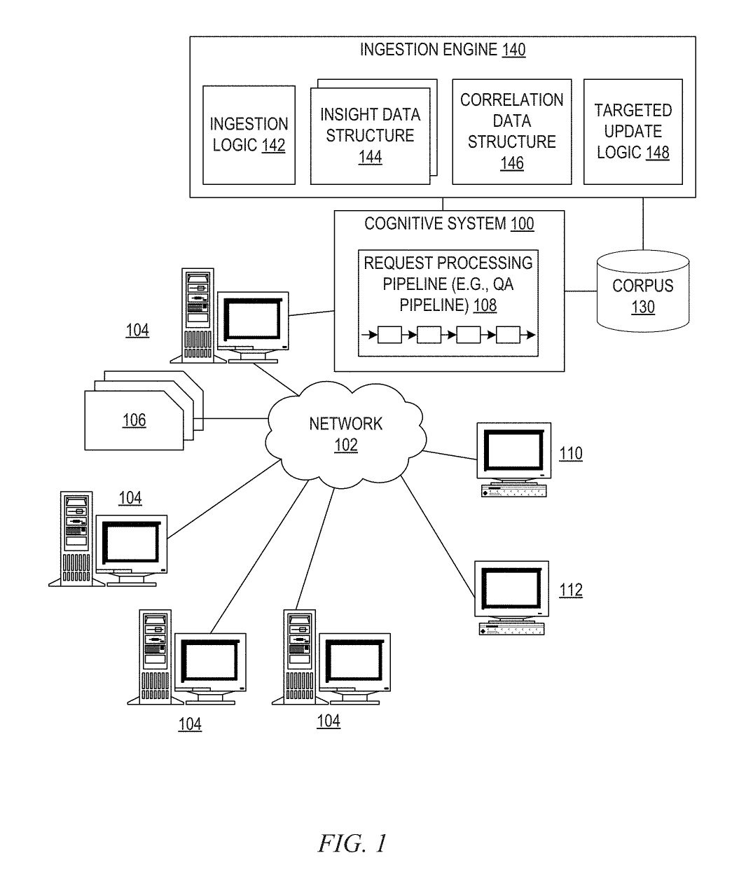

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example cognitive system for healthcare applications (also referred to herein as a “healthcare cognitive system”) which implements a request processing pipeline, such as a Question Answering (QA) pipeline (also referred to as a Question/Answer pipeline or Question and Answer pipeline) for example, request processing methodology, and request processing computer program product with which the mechanisms of the illustrative embodiments are implemented. These requests may be provided as structure or unstructured request messages, natural language questions, or any other suitable format for requesting an operation to be performed by the healthcare cognitive system. As described in more detail hereafter, the particular healthcare application that is implemented in the cognitive system of the present invention is a healthcare application for generating medical treatment recommendations. It should be appreciated that while the illustrative embodiments will be described herein with regard to a medical treatment recommendation system, the illustrative embodiments are not limited to such. Rather, the illustrative embodiments may be implemented with any cognitive system whose operations are based on an ingested corpus or corpora where content of the documents within the corpus or corpora may change. In the context of a treatment recommendation system, such changes may be to positional statements within medical guideline documents, medical bulletins, drug label inserts, or the like, that indicate the guidance for applicability of treatments to particular types of patients for particular types of medical conditions.

It should be appreciated that the healthcare cognitive system, while shown as having a single request processing pipeline in the examples hereafter, may in fact have multiple request processing pipelines. Each request processing pipeline may be separately trained and/or configured to process requests associated with different domains or be configured to perform the same or different analysis on input requests (or questions in implementations using a QA pipeline), depending on the desired implementation. For example, in some cases, a first request processing pipeline may be trained to operate on input requests directed to a first medical malady domain (e.g., various types of blood diseases) while another request processing pipeline may be trained to answer input requests in another medical malady domain (e.g., various types of cancers). In other cases, for example, the request processing pipelines may be configured to provide different types of cognitive functions or support different types of healthcare applications, such as one request processing pipeline being used for patient diagnosis, another request processing pipeline being configured for medical treatment recommendation, another request processing pipeline being configured for patient monitoring, etc.

Moreover, each request processing pipeline may have their own associated corpus or corpora that they ingest and operate on, e.g., one corpus for blood disease domain documents and another corpus for cancer diagnostics domain related documents in the above examples. In some cases, the request processing pipelines may each operate on the same domain of input questions but may have different configurations, e.g., different annotators or differently trained annotators, such that different analysis and potential answers are generated. The healthcare cognitive system may provide additional logic for routing input questions to the appropriate request processing pipeline, such as based on a determined domain of the input request, combining and evaluating final results generated by the processing performed by multiple request processing pipelines, and other control and interaction logic that facilitates the utilization of multiple request processing pipelines.

As noted above, one type of request processing pipeline with which the mechanisms of the illustrative embodiments may be utilized is a Question Answering (QA) pipeline. The description of example embodiments of the present invention hereafter will utilize a QA pipeline as an example of a request processing pipeline that may be augmented to include mechanisms in accordance with one or more illustrative embodiments. It should be appreciated that while the present invention will be described in the context of the cognitive system implementing one or more QA pipelines that operate on an input question, the illustrative embodiments are not limited to such. Rather, the mechanisms of the illustrative embodiments may operate on requests that are not posed as “questions” but are formatted as requests for the cognitive system to perform cognitive operations on a specified set of input data using the associated corpus or corpora and the specific configuration information used to configure the cognitive system. For example, rather than asking a natural language question of “What diagnosis applies to patient P?”, the cognitive system may instead receive a request of “generate diagnosis for patient P,” or the like. It should be appreciated that the mechanisms of the QA system pipeline may operate on requests in a similar manner to that of input natural language questions with minor modifications. In fact, in some cases, a request may be converted to a natural language question for processing by the QA system pipelines if desired for the particular implementation.

As will be discussed in greater detail hereafter, the illustrative embodiments may be integrated in, augment, and extend the functionality of these QA pipeline, or request processing pipeline, mechanisms of a healthcare cognitive system with regard to ingestion of documents of a corpus or corpora. In particular, the mechanisms of the illustrative embodiments improve the updating of insight data structures, which are a knowledge representation used by a cognitive system, based on changes to content of documents in a corpus or corpora, by providing targeted updates that target only the insight data structures affected by the specific changes to the specific portions of the documents, e.g., the specific insight data structures corresponding to the specific positional statements updated by the changes. As a result, the insight data structures are updated in a targeted manner without having to re-ingest the entire corpus or corpora and the changes may be used to modify the operations of the cognitive system, e.g., the new guidelines for the applicability of medical treatments indicated by the changes to positional statements may be utilized when generating treatment recommendations for patients.

In view of the above, it is important to first have an understanding of how cognitive systems and question and answer creation in a cognitive system implementing a QA pipeline is implemented before describing how the mechanisms of the illustrative embodiments are integrated in and augment such cognitive systems and request processing pipeline, or QA pipeline, mechanisms. It should be appreciated that the mechanisms described in FIGS. 1-3 are only examples and are not intended to state or imply any limitation with regard to the type of cognitive system mechanisms with which the illustrative embodiments are implemented. Many modifications to the example cognitive system shown in FIGS. 1-3 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The cognitive system 100 is implemented on one or more computing devices 104 (comprising one or more processors and one or more memories, and potentially any other computing device elements generally known in the art including buses, storage devices, communication interfaces, and the like) connected to the computer network 102. The network 102 includes multiple computing devices 104 in communication with each other and with other devices or components via one or more wired and/or wireless data communication links, where each communication link comprises one or more of wires, routers, switches, transmitters, receivers, or the like. The cognitive system 100 and network 102 enables question processing and answer generation (QA) functionality for one or more cognitive system users via their respective computing devices 110-112. Other embodiments of the cognitive system 100 may be used with components, systems, sub-systems, and/or devices other than those that are depicted herein.

The cognitive system 100 is configured to implement a QA pipeline 108 that receive inputs from various sources. For example, the cognitive system 100 receives input from the network 102, a corpus of electronic documents 106, cognitive system users, and/or other data and other possible sources of input. In one embodiment, some or all of the inputs to the cognitive system 100 are routed through the network 102. The various computing devices 104 on the network 102 include access points for content creators and QA system users. Some of the computing devices 104 include devices for a database storing the corpus of data 106 (which is shown as a separate entity in FIG. 1 for illustrative purposes only). Portions of the corpus of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus of data 106 for use as part of a corpus of data with the cognitive system 100. The document includes any file, text, article, or source of data for use in the cognitive system 100. QA system users access the cognitive system 100 via a network connection or an Internet connection to the network 102, and input questions to the cognitive system 100 that are answered by the content in the corpus of data 106. In one embodiment, the questions are formed using natural language. The cognitive system 100 parses and interprets the question via a QA pipeline 108, and provides a response to the cognitive system user, e.g., cognitive system user 110, containing one or more answers to the question. In some embodiments, the cognitive system 100 provides a response to users in a ranked list of candidate answers while in other illustrative embodiments, the cognitive system 100 provides a single final answer or a combination of a final answer and ranked listing of other candidate answers.

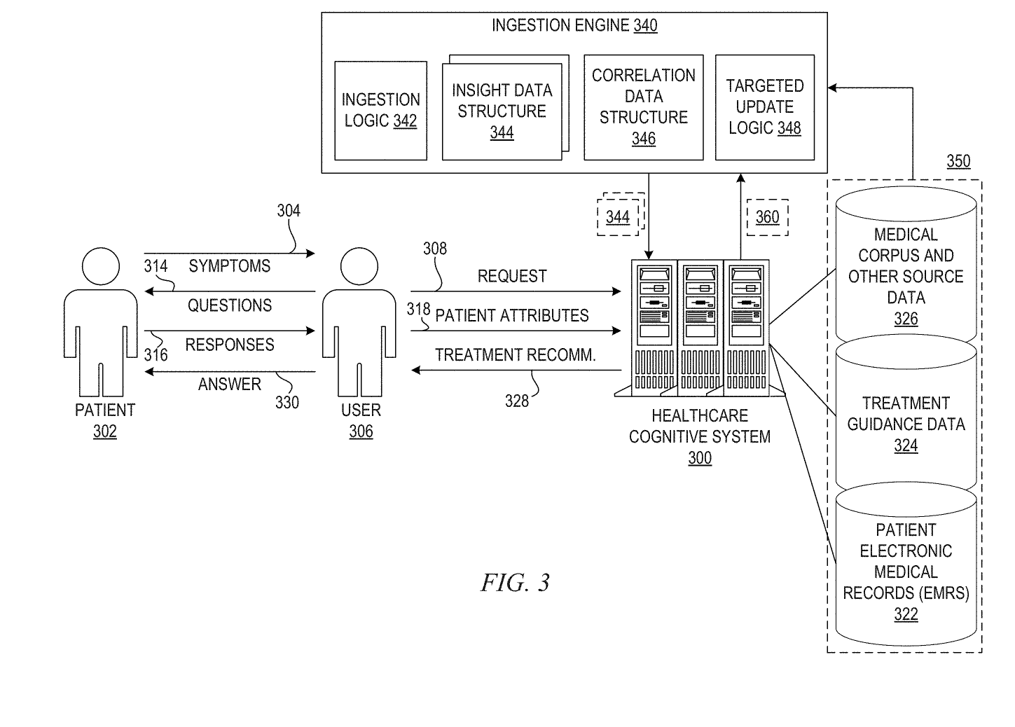

The cognitive system 100 implements the QA pipeline 108 which comprises a plurality of stages for processing an input question and the corpus of data 106. The QA pipeline 108 generates answers for the input question based on the processing of the input question and the corpus of data 106. The QA pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a QA pipeline of the IBM Watson™ cognitive system receives an input question which it then parses to extract the major features of the question, which in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question. The QA pipeline of the IBM Watson™ cognitive system then performs deep analysis on the language of the input question and the language used in each of the portions of the corpus of data found during the application of the queries using a variety of reasoning algorithms.

The scores obtained from the various reasoning algorithms are then weighted against a statistical model that summarizes a level of confidence that the QA pipeline of the IBM Watson™ cognitive system has regarding the evidence that the potential response, i.e. candidate answer, is inferred by the question. This process is be repeated for each of the candidate answers to generate ranked listing of candidate answers which may then be presented to the user that submitted the input question, or from which a final answer is selected and presented to the user. More information about the QA pipeline of the IBM Watson™ cognitive system may be obtained, for example, from the IBM Corporation website, IBM Redbooks, and the like. For example, information about the QA pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. In the case of a healthcare based cognitive system, this analysis may involve processing patient medical records, medical guidance documentation from one or more corpora, and the like, to provide a healthcare oriented cognitive system result.

In the context of the present invention, cognitive system 100 may provide a cognitive functionality for assisting with healthcare based operations. For example, depending upon the particular implementation, the healthcare based operations may comprise patient diagnostics, medical treatment recommendation systems, medical practice management systems, personal patient care plan generation and monitoring, patient electronic medical record (EMR) evaluation for various purposes, such as for identifying patients that are suitable for a medical trial or a particular type of medical treatment, or the like. Thus, the cognitive system 100 may be a healthcare cognitive system 100 that operates in the medical or healthcare type domains and which may process requests for such healthcare operations via the request processing pipeline 108 input as either structured or unstructured requests, natural language input questions, or the like.

In one illustrative embodiment, the cognitive system 100 is a medical treatment recommendation system that analyzes patient electronic medical records (EMRs) using knowledge gathered from the ingestion of one or more corpora, to generate one or more medical treatment recommendations for treating a medical condition of the patient. The one or more corpora may comprise various medical documents including official guideline documentation, medical information from websites, blogs, medical publications, medical insurance documentation, pharmacy information, or the like. The ingestion of the information in at least a portion of the one or more corpora results in one or more insight data structures being generated that represent the knowledge obtained from the portion of the one or more corpora. The insight data structures may be applied to attributes of patients as obtained from the patient EMRs to determine if the conditions of an insight data structure are met and the corresponding treatment recommendation should be applied to the patient to recommend a treatment for the patient's medical condition.

As shown in FIG. 1, the cognitive system 100 is further augmented, in accordance with the mechanisms of the illustrative embodiments, to include logic implemented in specialized hardware, software executed on hardware, or any combination of specialized hardware and software executed on hardware, for implementing an ingestion engine 140. The ingestion engine 140 comprises logic 142 for ingesting documents of one or more corpora, such as corpus 130, and generating insight data structures 144. For example, a document, such as a medical guideline document, in a corpus 130 may comprise a statement of the type “Female patients aged 40 or older, diagnosed with type 2 diabetes, and having a history of high blood pressure, can be prescribed treatment X to treat their diabetes.” This positional statement within the corpus 130 may be ingested and analyzed by the logic 142 to identify elements of the statement, such as medical condition (type 2 diabetes), patient gender (female), patient age (40+), patient attributes (high blood pressure), and treatment (treatment X). These extracted features of the positional statement may then be correlated in an insight data structure 144 which can be used by the cognitive system 100 to evaluate the attributes of patients as extracted from patient electronic medical records (EMRs) to determine if the conditions of the insight data structure are satisfied such that the corresponding treatment may be recommended for treating a medical condition of the patient.

In accordance with the illustrative embodiments, the ingestion logic 142 is modified to maintain correlations between insight data structures and corresponding portions of content in the corpus or corpora, such as in insight data structure correlation data structures 146. Thus, for example, a portion of a document, such as a medical guideline, may be identified by an identifier that specifically identifies that portion, e.g., one or more of document id, page, statement number, and/or word range, or the like. Any suitable identifier for specifically identifying a particular location of a portion of content may be utilized. In some cases, each statement in each document of a corpus or corpora may be given a unique identifier when it is ingested into the cognitive system 100, e.g. a unique identifier that combines document identifier, page identifier, statement number, and word range {document id, page id, statement #, word range}. This unique identifier may then be used to specifically identify the statement in a document of the corpus.

When that statement is ingested, the corresponding insight data structure 144 generated as part of the ingestion may be correlated with the statement's unique identifier, e.g., an entry in a database or other type of data structure that has a tuple that correlates the unique identifier to the particular insight record (or data structure) such as {statement unique identifier, insight record}. The correlation may be stored in the insight data structure correlation data structures 146.

The ingestion engine 140 further comprises targeted update logic 148 for obtaining changes to content in a corpus or corpora and performing targeted updates to insight data structures 144 based on the specific changes performed to the specific portions of content in the corpus or corpora. In particular when a change is made to a document of the corpus 130, such as an update to a positional statement in a medical guideline document, the change is signaled to the ingestion engine 140 and indicates the unique identifier of the portion of the document updated by the change. For example, the targeted update logic 148, or other monitoring logic (not shown), may continuously or periodically monitor the corpus or corpora for indicators of changes to the corpus or corpora. Various monitoring methodologies may be used depending on the desired implementation.

For example, the monitoring logic may monitor the document location for new documents to determine if the document itself has changed based on the date of the document file. Another methodology that may be employed is to find and identify document updates based on version information for document files, i.e. version information is incremented when changes occur and the most current version is thereby ingested by the ingestion engine. To find and detect updated or modified positional statements within the document, a lexical similarity match can be performed against the document, passage, or sentence that the original insight was derived from within the same section of the document.

The unique identifier of the portion of the document, e.g., a positional statement, is used by the targeted update logic 148 to perform a lookup operation for a corresponding insight data structure 144 via the insight data structure correlation data structures 146, which may be collectively referred to as a mapping data structure that maps the insights to positional statements, guidelines, or the like, which are the source of the corresponding insights. If an insight data structure correlation data structure 146 (hereafter referred to as a correlation data structure 146) exists for the particular unique identifier of the statement, then a corresponding insight data structure 144 is identified. If a correlation data structure 146 does not exist for the statement, then a new insight data structure 144 is generated for the statement and correlated with the statement in the correlation data structures 146.

In response to identifying a matching correlation data structure 146, the targeted update logic 148 retrieves the corresponding insight data structure 144 and compares the features of the insight data structure 144 to corresponding features extracted from the updated or changed statement in the document, such as extracted by the ingestion logic 142. Differences between the corresponding features are identified and the nature of those differences are determined to determine an adjustment to be applied to the insight data structure 144. For example, if the previous insight data structure indicates an age of the patient required for the treatment to be applicable is 40+, if the changed statement indicates an age of 35+, then the insight data structure 144 may be updated to change the age feature of the insight data structure 144 to be 35+. If, however, the change to the statement is that patients have an age of 40-50, then the age feature of the insight data structure 134 may be updated to be a range of 40-50.

The differences between the previous version of the positional statement and the current version of the positional statement may also be determined based on a comparison of the content of the statement using natural language processing techniques. In such a case, the terms and phrases of each statement may be compared to determine any differences and then those differences may be further analyzed, such as in a similar manner as noted above, to determine what features they correspond to and what the differences are in the values of those features, e.g., the previous version stated “females aged 40 or more” and the new version states “women at least 35 years or older” where the differences in terminology and phrasing are identified by natural language processing techniques and the particular features (age) are identified with the corresponding values (40+ in the previous version and 35+ in the new version).

The updated insight data structure 144 may then be utilized by the cognitive system 100 to perform its cognitive operations, such as a medical treatment recommendation operation. Thus, for example, the new patient attributes, new treatment, new conditions, or the like, that are associated with the updated or changed portion of content, e.g., a positional statement in a medical guideline document, may be applied by the cognitive system 100 when determining an appropriate medical treatment recommendation for a patient based on the patient's EMR. Thus, for example, where a female patient aged 37 may have previously not had treatment X recommended for treating her type 3 diabetes medical condition, after the update of the positional statement to reference an age range of 35+ in the updated positional statement, as opposed to 40+ in the previous positional statement, the treatment X may be a treatment recommendation that may be considered for recommendation to the patient. This treatment recommendation may be further evaluated based on evidence and other criteria in accordance with the cognitive operations of the cognitive system 100, such as confidence scoring based on evidential information in the corpus or corpora. For example, the application of the insight data structure 144 to the patient EMRs may be used to generate a candidate treatment recommendation as part of a hypothesis generation stage of the pipeline 108, as described in greater detail hereafter, which is then evaluated and ranked against other candidate treatment recommendations to select a best treatment recommendation for return to a user as the treatment being recommended for treating the patient.

It should be noted that, in accordance with the illustrative embodiments, only the corresponding insight data structure 144 is updated rather than having to re-ingest the entire corpus in which the portion of changed content is present. Moreover, incremental additions to the insight data structures may be made as new positional statements or other content are added to existing documents in a corpus or corpora. Thus, a targeted update of the insight data structure 144 is performed with minimal expenditure of resources.

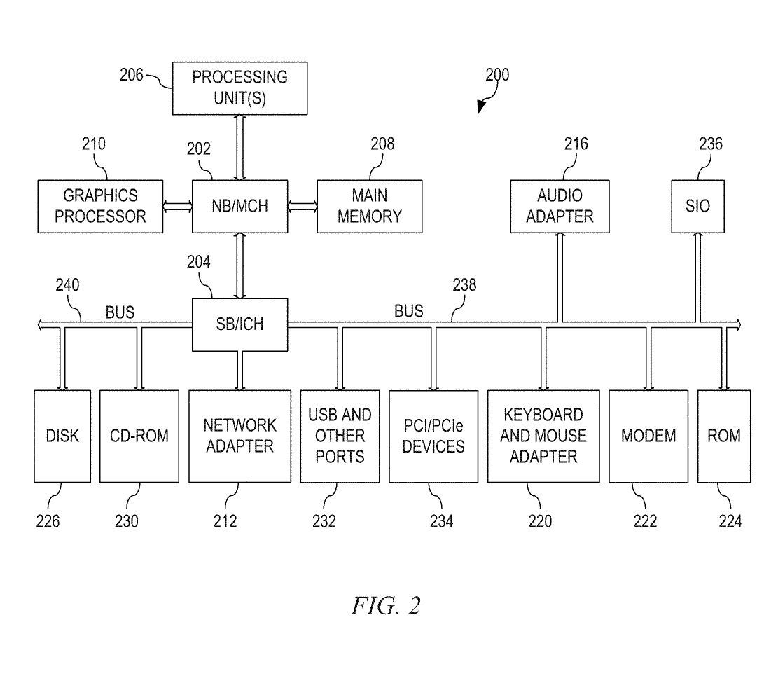

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including North Bridge and Memory Controller Hub (NB/MCH) 202 and South Bridge and Input/Output (I/O) Controller Hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 10®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 is an example diagram illustrating an interaction of elements of a healthcare cognitive system in accordance with one illustrative embodiment. The example diagram of FIG. 3 depicts an implementation of a healthcare cognitive system 300 that is configured to provide medical treatment recommendations for patients. However, it should be appreciated that this is only an example implementation and other healthcare operations may be implemented in other embodiments of the healthcare cognitive system 300 without departing from the spirit and scope of the present invention.

Moreover, it should be appreciated that while FIG. 3 depicts the patient 302 and user 306 as human figures, the interactions with and between these entities may be performed using computing devices, medical equipment, and/or the like, such that entities 302 and 306 may in fact be computing devices, e.g., client computing devices. For example, the interactions 304, 314, 316, and 330 between the patient 302 and the user 306 may be performed orally, e.g., a doctor interviewing a patient, and may involve the use of one or more medical instruments, monitoring devices, or the like, to collect information that may be input to the healthcare cognitive system 300 as patient attributes 318. Interactions between the user 306 and the healthcare cognitive system 300 will be electronic via a user computing device (not shown), such as a client computing device 110 or 112 in FIG. 1, communicating with the healthcare cognitive system 300 via one or more data communication links and potentially one or more data networks.

As shown in FIG. 3, in accordance with one illustrative embodiment, a patient 302 presents symptoms 304 of a medical malady or condition to a user 306, such as a healthcare practitioner, technician, or the like. The user 306 may interact with the patient 302 via a question 314 and response 316 exchange where the user gathers more information about the patient 302, the symptoms 304, and the medical malady or condition of the patient 302. It should be appreciated that the questions/responses may in fact also represent the user 306 gathering information from the patient 302 using various medical equipment, e.g., blood pressure monitors, thermometers, wearable health and activity monitoring devices associated with the patient such as a FitBit™, a wearable heart monitor, or any other medical equipment that may monitor one or more medical characteristics of the patient 302. In some cases such medical equipment may be medical equipment typically used in hospitals or medical centers to monitor vital signs and medical conditions of patients that are present in hospital beds for observation or medical treatment.

In response, the user 302 submits a request 308 to the healthcare cognitive system 300, such as via a user interface on a client computing device that is configured to allow users to submit requests to the healthcare cognitive system 300 in a format that the healthcare cognitive system 300 can parse and process. The request 308 may include, or be accompanied with, information identifying patient attributes 318. These patient attributes 318 may include, for example, an identifier of the patient 302 from which patient EMRs 322 for the patient may be retrieved, demographic information about the patient, the symptoms 304, and other pertinent information obtained from the responses 316 to the questions 314 or information obtained from medical equipment used to monitor or gather data about the condition of the patient 302. Any information about the patient 302 that may be relevant to a cognitive evaluation of the patient by the healthcare cognitive system 300 may be included in the request 308 and/or patient attributes 318.

The healthcare cognitive system 300 provides a cognitive system that is specifically configured to perform an implementation specific healthcare oriented cognitive operation. In the depicted example, this healthcare oriented cognitive operation is directed to providing a treatment recommendation 328 to the user 306 to assist the user 306 in treating the patient 302 based on their reported symptoms 304 and other information gathered about the patient 302 via the question 314 and response 316 process and/or medical equipment monitoring/data gathering. The healthcare cognitive system 300 operates on the request 308 and patient attributes 318 utilizing information gathered from the medical corpus and other source data 326, treatment guidance data 324, and the patient EMRs 322 associated with the patient 302 to generate one or more treatment recommendation 328. The treatment recommendations 328 may be presented in a ranked ordering with associated supporting evidence, obtained from the patient attributes 318 and data sources 322-326, indicating the reasoning as to why the treatment recommendation 328 is being provided and why it is ranked in the manner that it is ranked.

For example, based on the request 308 and the patient attributes 318, the healthcare cognitive system 300 may operate on the request, such as by using a QA pipeline type processing as described herein, to parse the request 308 and patient attributes 318 to determine what is being requested and the criteria upon which the request is to be generated as identified by the patient attributes 318, and may perform various operations for generating queries that are sent to the data sources 322-326 to retrieve data, generate candidate treatment recommendations (or answers to the input question), and score these candidate treatment recommendations based on supporting evidence found in the data sources 322-326. In the depicted example, the patient EMRs 322 is a patient information repository that collects patient data from a variety of sources, e.g., hospitals, laboratories, physicians' offices, health insurance companies, pharmacies, etc. The patient EMRs 322 store various information about individual patients, such as patient 302, in a manner (structured, unstructured, or a mix of structured and unstructured formats) that the information may be retrieved and processed by the healthcare cognitive system 300. This patient information may comprise various demographic information about patients, personal contact information about patients, employment information, health insurance information, laboratory reports, physician reports from office visits, hospital charts, historical information regarding previous diagnoses, symptoms, treatments, prescription information, etc. Based on an identifier of the patient 302, the patient's corresponding EMRs 322 from this patient repository may be retrieved by the healthcare cognitive system 300 and searched/processed to generate treatment recommendations 328.

The treatment guidance data 324 provides a knowledge base of medical knowledge that is used to identify potential treatments for a patient based on the patient's attributes 318 and historical information presented in the patient's EMRs 322. This treatment guidance data 324 may be obtained from official treatment guidelines and policies issued by medical authorities, e.g., the American Medical Association, may be obtained from widely accepted physician medical and reference texts, e.g., the Physician's Desk Reference, insurance company guidelines, or the like. The treatment guidance data 324 may be provided in any suitable form that may be ingested by the healthcare cognitive system 300 including both structured and unstructured formats.

In some cases, such treatment guidance data 324 may be provided in the form of rules that indicate the criteria required to be present, and/or required not to be present, for the corresponding treatment to be applicable to a particular patient for treating a particular symptom or medical malady/condition. These rules use a set of insight data structures to make a decision. Thus, for example, each of the conditions for a rule can be determined by processing or using an insight data structure. For example, an insight data structure generated from a positional statement or guideline may be “females under 60 years old” and one of the conditions for a treatment rule may be “age<=60.”

For example, the treatment guidance data 324 may comprise a treatment recommendation rule that indicates that for a treatment of Decitabine, strict criteria for the use of such a treatment is that the patient 302 is less than or equal to 60 years of age, has acute myeloid leukemia (AML), and no evidence of cardiac disease. Thus, for a patient 302 that is 59 years of age, has AML, and does not have any evidence in their patient attributes 318 or patient EMRs indicating evidence of cardiac disease, the following conditions of the treatment rule exist:

Age<=60 years=59 (MET);

Patient has AML=AML (MET); and

Cardiac Disease=false (MET)

Since all of the criteria of the treatment rule are met by the specific information about this patient 302, then the treatment of Decitabine is a candidate treatment for consideration for this patient 302. However, if the patient had been 69 years old, the first criterion would not have been met and the Decitabine treatment would not be a candidate treatment for consideration for this patient 302. Various potential treatment recommendations may be evaluated by the healthcare cognitive system 300 based on ingested treatment guidance data 324 to identify subsets of candidate treatments for further consideration by the healthcare cognitive system 300 by scoring such candidate treatments based on evidential data obtained from the patient EMRs 322 and medical corpus and other source data 326.

For example, data mining processes may be employed to mine the data in sources 322 and 326 to identify evidential data supporting and/or refuting the applicability of the candidate treatments to the particular patient 302 as characterized by the patient's patient attributes 318 and EMRs 322. For example, for each of the criteria of the treatment rule, the results of the data mining provides a set of evidence that supports giving the treatment in the cases where the criterion is “MET” and in cases where the criterion is “NOT MET.” The healthcare cognitive system 300 processes the evidence in accordance with various cognitive logic algorithms to generate a confidence score for each candidate treatment recommendation indicating a confidence that the corresponding candidate treatment recommendation is valid for the patient 302. The candidate treatment recommendations may then be ranked according to their confidence scores and presented to the user 306 as a ranked listing of treatment recommendations 328. In some cases, only a highest ranked, or final answer, is returned as the treatment recommendation 328. The treatment recommendation 328 may be presented to the user 306 in a manner that the underlying evidence evaluated by the healthcare cognitive system 300 may be accessible, such as via a drilldown interface, so that the user 306 may identify the reasons why the treatment recommendation 328 is being provided by the healthcare cognitive system 300.

In accordance with the illustrative embodiments herein, the healthcare cognitive system 300 is augmented to include an ingestion engine 340 that includes ingestion logic 342, insight data structures 344, correlation data structure 346, and targeted updated logic 348, which each may operate in the manner previously described with regard to elements 142-148 of ingestion engine 140 in FIG. 1, for example. The ingestion engine 340 operates to ingest one or more corpora 350 of information, such as information from sources 322-326, to generate in-memory representations of this information for use by the healthcare cognitive system 300. In particular, the ingestion engine 340 may operate to ingest, potentially in addition to other types of structure and/or unstructured information from the corpora 350, medical treatment guideline documents having one or more positional statements in the content of these medical treatment guideline documents. These positional statements state a position with regard to when a particular treatment is appropriate for treating a patient for a specified medical condition. The sources of such medical treatment guideline documents are varied, e.g., government issued documentation, pharmaceutical company guideline documents for various pharmaceuticals, medical association guideline documents, or the like, and any such source of a medical treatment guideline document may be used without departing from the spirit and scope of the present invention. The ingestion operation comprises performing natural language and/or structured format based processing of the content of the corpora 350 which includes extracting features and values from the content to represent knowledge present in the content.

Thus, in accordance with one illustrative embodiment, a corpus of medical treatment guidelines is initially ingested by the ingestion engine 340, which may be part of the healthcare cognitive system 300 or may be a separate system from the healthcare cognitive system 300 such as shown in FIG. 3 for purposes of illustration. The ingestion logic 342 of the ingestion engine 340, as part of its feature extraction and value extraction from the medical treatment guidelines, generates insight data structures 344 that indicate medical treatments, the conditions under which such medical treatments are applicable to patients, and potentially the manner by which such medical treatments are to be administered to patients. Other information extracted from positional statements within medical treatment guidelines may also be part of the insight data structures 344 without departing from the spirit and scope of the present invention.

The insight data structures 344 are tied to the specific positional statements/medical guidelines documents that are the source of the insights represented by the insight data structures 344. As noted above, each positional statement may have a unique identifier that is mapped to the resulting insight data structure 344 generated from that positional statement. The mapping of the unique identifier of the positional statement to the insight data structure may be maintained by the ingestion engine 340 in the correlation data structure 346. In this way, the particular positional statement/guidelines that were the basis for the particular insight represented by the insight data structure is able to be identified.

In accordance with some illustrative embodiments, this insight information represented by the insight data structures 344 may be used by the healthcare cognitive system 300 to analyze patient electronic medical records (EMRs) and return treatment recommendations based on the specific patient's medical condition, medical history, personal attributes, and other information as indicated in the patient EMR. As noted above, this insight information may change from time to time based on changes made to the guidelines and/or positional statements within these guidelines. The ingestion engine 340 comprises targeted update logic 348 to perform targeted updating of the insight data structures 344 affected by the changes to positional statements in medical guidelines present in the corpora 350.

When a change is made to a document in the corpora 350, such as a change to a positional statement in a medical guideline document, the logic of the healthcare cognitive system 300 and/or the ingestion engine 340 is signaled by a monitoring system, or other monitoring logic in the ingestion engine 340, such as may be in the ingestion logic 342, targeted update logic 348, or the like. The monitoring logic monitors for file changes, may providing versioning logic for files, or the like, and may be built upon file readers and file directory monitoring for changes as well as naming conventions or versioning conventions used by the system. In some embodiments, the system may utilize designated directories for new files that are consumed and moved once processed. Any mechanism for monitoring for modifications to documents in a corpus or corpora 350 may be used without departing from the spirit and scope of the present invention.

The signaling indicates the unique identifier of the portion of the document that was changed, e.g., document identifier, page identifier, line numbers, word range, and/or the like within the document that were changed, or another type of unique identifier of the portion of content (e.g., the specific positional statement that was changed). In some cases the specific changed portion of content itself is also provided as part of the signaling notification sent to the healthcare cognitive system 300 and/or ingestion engine 340.

The identification of the portion of content that was changed is used by the targeted update logic 348 to perform a lookup operation in the correlation data structure 346 to identify an insight data structure 344 corresponding to the changed portion of content, e.g., changed positional statement (it will be assumed hereafter for ease of explanation that the portion of content is a positional statement within a medical treatment guideline document of the corpora 350). If there is an existing insight data structure 344 for the changed positional statement, then the corresponding insight data structure 344 is retrieved and the features/values of the previous version of the positional statement are compared to features/values extracted from the changed positional statement. As noted above, this may involve performing natural language processing on the two versions of the statements and comparing the features/values extracted as part of this natural language process.

For example, the terms and phrases of the two versions of the positional statements may be compared by comparison logic within the targeted update logic 348 to determine the particular changes made. These particular changes may be further analyzed by the targeted update logic 348 to determine the nature of the change. For example, the original positional statement may have been “The drug Pioglitazone can be used with patients up to 70 years old”, whereas the update to this positional statement may change it to read “The drug Piotlitazone can be used with patients up to 65 years old and have no history of congestive heart failure.” In this example, the original insight record would have an insight data structure of Pioglitozone use age <=70. The new insight data structure would be Pioglitozone use age <=65, Pioglitozone use CHF=false. The change indicates there will be a simple update to the data insight structure for an age, but a new entry for CHF=false will be added to the insight, from the same updated positional statement with the corresponding unique identifier. Thus, the nature of the change in this example is the updating of the age and the addition of a new requirement.

The nature of the change may then be correlated by the targeted update logic 348 with a particular adjustment to be applied to the corresponding insight data structure 344 to generate a modified insight data structure 344. As such, the targeted update logic 348 may make use of natural language processing mechanisms present in the healthcare cognitive system 300 to help facilitate the operations of the targeted update logic 348 or may have its own implementation of natural language processing mechanisms which are utilized.

For example, in 2016, the American Diabetes Association (ADA) recommends that people over 45 have their HbA1C checked to see if they have diabetes or are at risk for diabetes. Originally, this recommendation may have previously stated that people over 50 should have their HbA1C checked which would have resulting in an insight of “Run HbA1C when age >50.” With the change in the recommendation by the ADA, the two positional statements may be compared to identify that the change in the positional statement is an age value (nature of the change). Thus, the age value in the previously generated insight data structure should be updated to reflect the change in the positional statement (adjustment to be made). As a result, the insight would be adjusted to “Run HbA1C when age >45” (modified insight data structure). The new insight is mapped to the changed positional statement in case future changes to this positional statement are made (updated correlation data structure).

The modified insight data structure 344 may be stored by the ingestion engine 340 and associated with the unique identifier of the positional statement in the correlation data structure 346 in replacement of the previous version of the insight data structure 344 and entry in the correlation data structure 346. These insight data structures 344 are provided to, or otherwise made available to, the healthcare cognitive system 300 which may perform its cognitive operations based on the insight data structures 344. Thus, the modified insight data structure 344 for the changed positional statement will be provided to the healthcare cognitive system 300 which will thereafter utilize the updated information to perform its cognitive operations. As noted above, these cognitive operations may comprise performing treatment recommendation generation such that the treatment recommendation 328 sent back to the user 306 may in fact be based on the healthcare cognitive system 300 operation on the modified insight data structure 344. For example, the modified insight data structure 344 may be used by the healthcare cognitive system 300 as part of a process of hypothesis generation for generating candidate treatment recommendations for further evaluation by the healthcare cognitive system 300. The healthcare cognitive system 300 may then perform evidence based confidence scoring based on other information present within the corpora 350 to determine a confidence score for a candidate treatment recommendations, rank them according to confidence score, select one or more treatment recommendations to be returned to the user 306, and may then transmit or otherwise output the treatment recommendation 328 to the user 306 based on the confidence scoring, ranking, and selection.

While FIG. 3 is depicted with an interaction between the patient 302 and a user 306, which may be a healthcare practitioner such as a physician, nurse, physician's assistant, lab technician, or any other healthcare worker, for example, the illustrative embodiments do not require such. Rather, the patient 302 may interact directly with the healthcare cognitive system 300 without having to go through an interaction with the user 306 and the user 306 may interact with the healthcare cognitive system 300 without having to interact with the patient 302. For example, in the first case, the patient 302 may be requesting 308 treatment recommendations 328 from the healthcare cognitive system 300 directly based on the symptoms 304 provided by the patient 302 to the healthcare cognitive system 300. Moreover, the healthcare cognitive system 300 may actually have logic for automatically posing questions 314 to the patient 302 and receiving responses 316 from the patient 302 to assist with data collection for generating treatment recommendations 328. In the latter case, the user 306 may operate based on only information previously gathered and present in the patient EMR 322 by sending a request 308 along with patient attributes 318 and obtaining treatment recommendations in response from the healthcare cognitive system 300. Thus, the depiction in FIG. 3 is only an example and should not be interpreted as requiring the particular interactions depicted when many modifications may be made without departing from the spirit and scope of the present invention.

As mentioned above, the healthcare cognitive system 300 may include a request processing pipeline, such as request processing pipeline 108 in FIG. 1, which may be implemented, in some illustrative embodiments, as a Question Answering (QA) pipeline. The QA pipeline may receive an input question, such as “what is the appropriate treatment for patient P?”, or a request, such as “diagnose and provide a treatment recommendation for patient P.” Thus, while the natural language processing and treatment recommendation generation and selection operations may be performed by a “QA” pipeline, the input initiating such operations may take the form of a question, a request, or any other input that specifies the nature of result being sought.

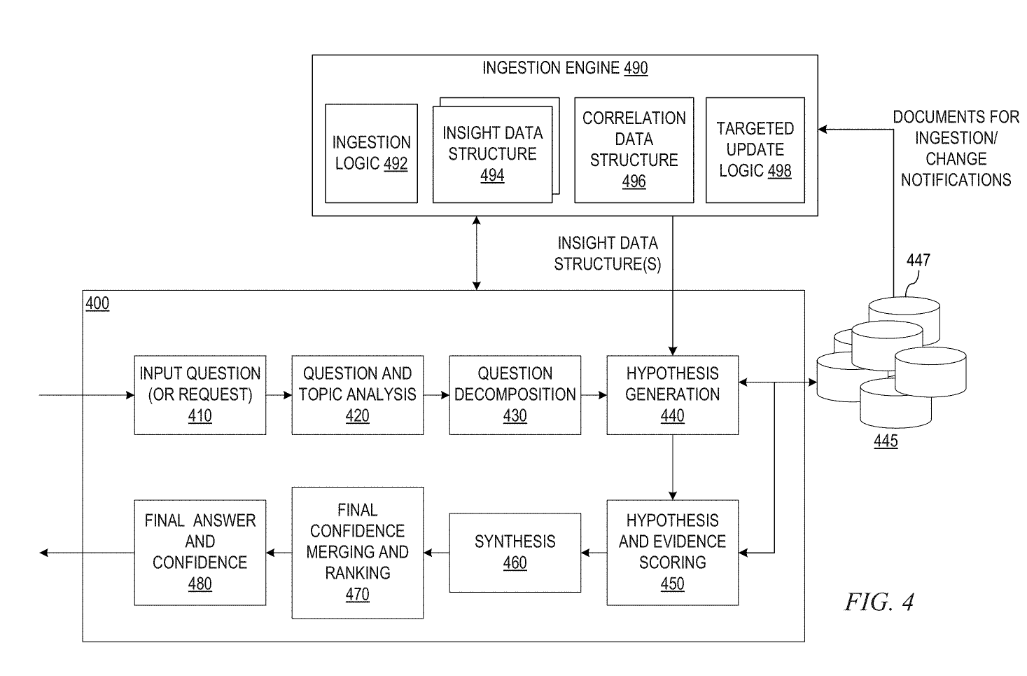

FIG. 4 illustrates a QA pipeline of a healthcare cognitive system, such as healthcare cognitive system 300 in FIG. 3, or an implementation of cognitive system 100 in FIG. 1, for processing an input question in accordance with one illustrative embodiment. It should be appreciated that the stages of the QA pipeline shown in FIG. 4 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA pipeline of FIG. 4 is augmented, for example, in one or more of the stages to implement the improved mechanism of the illustrative embodiments described hereafter, additional stages may be provided to implement the improved mechanism, or separate logic from the pipeline 400 may be provided for interfacing with the pipeline 400 and implementing the improved functionality and operations of the illustrative embodiments.

As shown in FIG. 4, the QA pipeline 400 comprises a plurality of stages 410-480 through which the cognitive system operates to analyze an input question and generate a final response. In an initial question input stage 410, the QA pipeline 400 receives an input question that is presented in a natural language format. That is, a user inputs, via a user interface, an input question for which the user wishes to obtain an answer, e.g., “What medical treatments for diabetes are applicable to a 60 year old patient with cardiac disease?” In response to receiving the input question, the next stage of the QA pipeline 400, i.e. the question and topic analysis stage 420, parses the input question using natural language processing (NLP) techniques to extract major features from the input question, and classify the major features according to types, e.g., names, dates, or any of a plethora of other defined topics. For example, in a question of the type “Who were Washington's closest advisors?”, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic. Similarly, in the previous question “medical treatments” may be associated with pharmaceuticals, medical procedures, holistic treatments, or the like, “diabetes” identifies a particular medical condition, “60 years old” indicates an age of the patient, and “cardiac disease” indicates an existing medical condition of the patient.

In addition, the extracted major features include key words and phrases, classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 4, the identified major features are then used during the question decomposition stage 430 to decompose the question into one or more queries that are applied to the corpora of data/information 445 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 445. That is, these various sources themselves, different collections of sources, and the like, represent a different corpus 447 within the corpora 445. There may be different corpora 447 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Food and Drug Administration (FDA) while another corpus may be American Medical Association (AMA) documents. Any collection of content having some similar attribute may be considered to be a corpus 447 within the corpora 445.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 440 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 440, to generate hypotheses for answering the input question. These hypotheses are also referred to herein as “candidate answers” for the input question. For any input question, at this stage 440, there may be hundreds of hypotheses or candidate answers generated that may need to be evaluated.

The QA pipeline 400, in stage 450, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 460, the large number of scores generated by the various reasoning algorithms are synthesized into confidence scores or confidence measures for the various hypotheses. This process involves applying weights to the various scores, where the weights have been determined through training of the statistical model employed by the QA pipeline 400 and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 400 that identifies a manner by which these scores may be combined to generate a confidence score or measure for the individual hypotheses or candidate answers. This confidence score or measure summarizes the level of confidence that the QA pipeline 400 has about the evidence that the candidate answer is inferred by the input question, i.e. that the candidate answer is the correct answer for the input question.

The resulting confidence scores or measures are processed by a final confidence merging and ranking stage 470 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 480, a final answer and confidence score, or final set of candidate answers and confidence scores, are generated and output to the submitter of the original input question via a graphical user interface or other mechanism for outputting information.

As shown in FIG. 4, in accordance with one illustrative embodiment, an ingestion engine 490, similar to ingestion engines 140 and 340 discussed above, is provided to operate in conjunction with the QA pipeline 400. The elements 492-498 operate in a similar manner to corresponding elements 142-148 and/or 342-348 in FIGS. 1 and 3, respectively. With regard to FIG. 4, it is noted that in the depicted example embodiment, the ingestion engine provides the insight data structures 494 generated as part of an initial ingestion operation, and/or modified insight data structures 494 generated as a result of a change to a positional statement in a document of a corpus or corpora 445, 447, to the hypothesis generation stage logic 440 to assist with the generation of candidate treatment recommendations for responding to the input question or request 410. The hypothesis generation stage logic 440 may apply the criteria of the insight data structures 494 to the particular information gathered for the patient as a result of the input question or request 410, such as patient EMR data obtained from the corpus or corpora 445, 447, to determine which insight data structures 494 have their criteria met by this particular patient. The medical treatments associated with the resulting insight data structures 494 whose criteria are met by the patient's information, such as from the patient EMR data, may then be selected as candidate treatment recommendations by the hypothesis generation logic 440. These candidate treatment recommendations may then be the subject of further analysis and processing by stages 450-480.

As shown in FIG. 4, the ingestion engine 490 is provided with change notifications, or signaling of changes, indicating portions of documents in the corpus or corpora 445, 447 which have been changed. These notifications may include a unique identifier of the portion of the document changed and may include the actual changed text of the portion of the document that was changed. In response to such a signal or change notification, the ingestion engine 490 performs its targeted updating of the insight data structures 494 that are affected by the change as discussed above. The resulting modified insight data structure(s) may then be provided to the hypothesis generation stage logic 440 for use in processing future input questions or requests 410. It should be noted that this process of targeted updating of insight data structures is performed without having to re-ingest the entire corpus or corpora 445, 447.

It should be appreciated that while FIG. 4 illustrates the insight data structures being provided to the hypothesis generation stage logic 440, this is only one example embodiment. Other illustrative embodiments may utilize the insight data structures in one or more of the other stages of the QA pipeline 400 without departing from the spirit and scope of the present invention, e.g., during question decomposition 430 to generate queries against a patient EMR, during hypothesis and evidence scoring 450 so as to generate confidence scores based on matching of a patient EMR to insight data structures 494 for candidate treatment recommendations, or the like. Depending on the desired implementation, the insight data structures may be used with various logic at various stages of question or request processing without departing from the spirit and scope of the present invention.

Thus, the illustrative embodiments provide mechanisms for performing targeted updating of insight data structures representing knowledge extracted from a corpus or corpora without having to re-ingest the entire corpus or corpora. The targeted updating of insight data structures determines the particular portion of a corpus or corpora that has been changed, determines the insight data structures affected by the change, and updates those insight data structures affected by the change without having to rebuild all of the insight data structures through a full re-ingestion of the corpus or corpora. In this way, large expenditures of resources to accommodate changes to a corpus or corpora are avoided. In particular, in some illustrative embodiments, these mechanisms facilitate the routine or periodic updating of medical positional statements in medical guideline documents with regard to treatment of patients for various medical conditions without having to re-ingest large corpora of medical documentation.

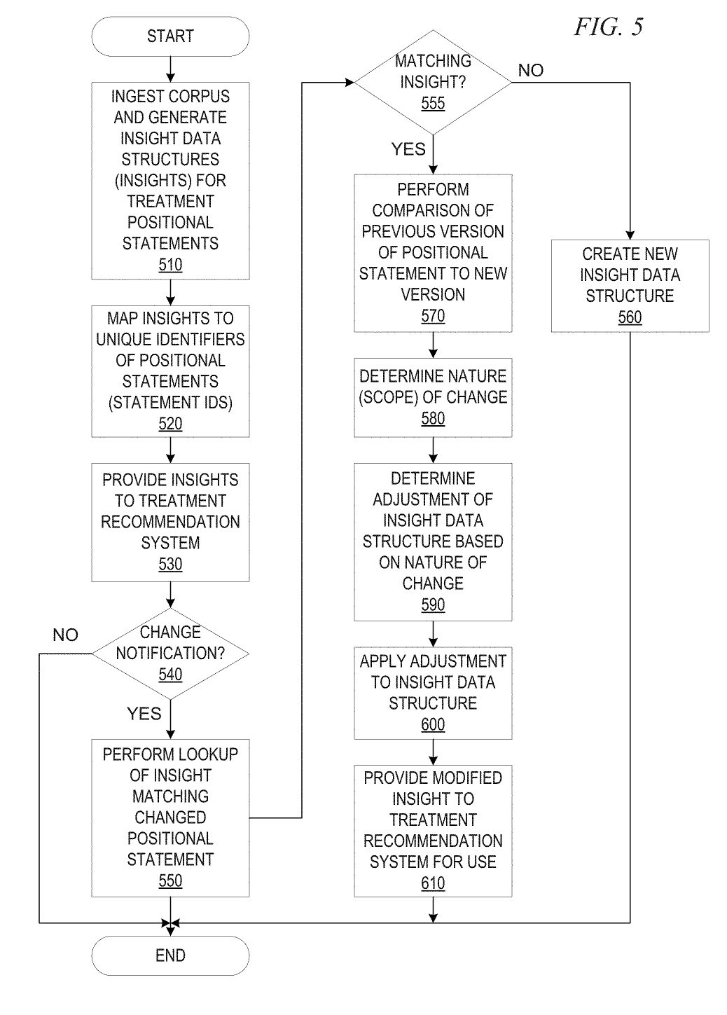

FIG. 5 is a flowchart outlining an example operation for performing an update to an insight data structure based on a change to a positional statement in accordance with one illustrative embodiment. As shown in FIG. 5, the operation starts by ingesting a corpus and generating an initial set of insight data structures (also referred to simply as “insights”) for medical treatment positional statements present in documents of the corpus, e.g., medical guideline documents (step 510). The insights are mapped to unique identifiers of the positional statements from which the insights were obtained (step 520). The insights are then provided to the treatment recommendation system for use in generating treatment recommendations for patients based on the patient's personal information, such as may be obtained from patient EMRs for example (step 530).

A determination is made as to whether a change notification has been received indicating that a positional statement in the corpus has been changed (step 550). If not, the operation ends. While the figure shows the operation ending, it should be appreciated that this check for a change notification may be performed periodically, continuously, or may represent the receipt of a change notification which initiates the subsequent operations as discussed hereafter. Thus, while for purposes of description the operation ends if there is no change notification, in fact the change notification check of step 540 may be representative of any operation that would initiate the performance of the subsequent operations 550-610.

In response to a change notification having been received (step 540), a lookup of a matching insight data structure for the changed positional statement is performed (step 550). A determination is made as to whether a matching insight data structure is found (step 555). If not, then a new insight data structure is generated for the positional statement (step 560). If a matching insight data structure is found, then a comparison of the previous version of the positional statement with the new version is performed (step 570). Based on this comparison, the nature or scope of the change is determined (step 580) and an adjustment to the insight data structure based on the nature or scope of the change is determined (step 590). The adjustment is then applied to the insight data structure to generate a modified or updated insight data structure (step 600). The modified or updated insight data structure is then provided to the treatment recommendation system for use in providing treatment recommendations for patients in response to subsequent questions or requests received by the treatment recommendation system (step 610). The operation then terminates.

It should be appreciated that while the above illustrative embodiments are described primarily with regard to updating an existing insight data structure based on modifications to a positional statement or guideline, the illustrative embodiments are not limited to such. Rather, or in addition, the updating of insight data structures may comprise adding new insight data structures and/or deleting existing data structures. That is the modification to a positional statement or guideline may be one of a change to an existing positional statement or existing guideline, the addition of a new positional statement or new guideline, or the deletion of an existing positional statement or existing guideline. In the case that the modification is to add a new positional statement or new guideline, then the updating of the insight data structure may comprise adding a new corresponding insight data structure. In the case where the modification is a removal of an existing positional statement or guideline, then the updating of the insight data structure may be deleting the affected insight data structure.

In addition, it should be noted that while the illustrative embodiments are primarily described with regard to updating insight data structures associated with medical treatment positional statements or guidelines, the illustrative embodiments are not limited to such. Rather, the illustrative embodiments are applicable to any domain where positional statements and/or guidelines are present and which may be modified such that they would affect insight data structures generated from them. For example domains in law enforcement, financial domains, governmental regulation domains, and the like, may all utilize such positional statements or guidelines upon which the mechanisms of the illustrative embodiments may operate so as to dynamically update corresponding insight data structures.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising at least one processor and at least one memory, the at least one memory comprising instructions executed by the at least one processor to cause the at least one processor to implement a cognitive system, the method comprising:
ingesting, by the cognitive system, a corpus of content, wherein the corpus of content comprises a plurality of guideline documents having one or more positional statements;
generating, by the cognitive system, a set of insight data structures based on the ingested corpus, wherein the set of insight data structures are mapped to corresponding positional statements or guidelines in the content of the corpus from which the insight data structures were generated;
receiving, by the cognitive system, a modification to a positional statement or guideline in the corpus;
determining, by the cognitive system, an insight data structure affected by the modification to the positional statement or guideline based on the set of insight data structures and the mapping to corresponding positional statements or guidelines;
updating, by the cognitive system, the affected insight data structure, without re-ingesting the entire corpus, to generate an updated set of insight data structures; and
performing, by the cognitive system, a cognitive operation based on the updated set of insight data structures.

2. The method of claim 1, wherein the cognitive system is a medical treatment recommendation cognitive system and the guidelines and one or more positional statements are guidelines and positional statements associated with defining criteria for applicability of medical treatments for one or more medical conditions of patients.

3. The method of claim 2, wherein the insight data structures are in-memory representations of medical treatment guideline positional statements for the application of medical treatments to patients having specified medical conditions.

4. The method of claim 1, wherein the modification is one of a change to an existing positional statement or existing guideline, the addition of a new positional statement or new guideline, or the deletion of an existing positional statement or existing guideline, and wherein updating the affected insight data structure comprises at least one of modifying a parameter of the affected insight data structure based on the modification, adding a new insight data structure, or deleting the affected insight data structure.

5. The method of claim 1, wherein determining an insight data structure affected by the modification comprises:
determining, by the cognitive system, a scope of change of the modification of the positional statement or guideline; and
determining, by the cognitive system, an adjustment to be applied to an insight data structure mapped to the modified positional statement or guideline based on the scope of change.

6. The method of claim 5, wherein updating the affected insight data structure comprises:
applying, by the cognitive system, the determined adjustment to the insight data structure.

7. The method of claim 2, wherein the cognitive operation comprises:
analyzing a patient electronic medical record based on the updated set of insight data structures; and
outputting a medical treatment recommendation for treating a patient corresponding to the patient electronic medical record.

8. The method of claim 1, wherein each insight data structure has, in a mapping data structure, an associated unique identifier that links the insight data structure to a portion of a corresponding positional statement or guideline in the content of the corpus, and wherein determining an insight data structure affected by the modification to the positional statement or guideline comprises performing a lookup operation in the mapping data structure based on a unique identifier associated with the modified positional statement or guideline.

9. The method of claim 8, wherein the unique identifier comprises one or more of a document identifier, page identifier, statement number, or word range.

10. The method of claim 2, wherein the cognitive operation is the generation and output of a medical treatment recommendation for treating a medical condition of a patient by evaluating a patient electronic medical record based on the updated insight data structure to determine if a medical treatment associated with the updated insight data structure applies to the medical condition of the patient and the patient's characteristics match requirements set forth in the updated insight data structure.

11. A computer program product comprising a computer readable storage medium having a computer readable program stored therein, wherein the computer readable program, when executed on a computing device, causes the computing device to implement a cognitive system which operates to:
ingest a corpus of content, wherein the corpus of content comprises a plurality of guideline documents having one or more positional statements;
generate a set of insight data structures based on the ingested corpus, wherein the set of insight data structures are mapped to corresponding positional statements or guidelines in the content of the corpus from which the insight data structures were generated;
receive a modification to a positional statement or guideline in the corpus;
determine an insight data structure affected by the modification to the positional statement or guideline based on the set of insight data structures and the mapping to corresponding positional statements or guidelines;
update the affected insight data structure, without re-ingesting the entire corpus, to generate an updated set of insight data structures; and
perform a cognitive operation based on the updated set of insight data structures.

12. The computer program product of claim 11, wherein the cognitive system is a medical treatment recommendation cognitive system and the guidelines and one or more positional statements are guidelines and positional statements associated with defining criteria for applicability of medical treatments for one or more medical conditions of patients.

13. The computer program product of claim 12, wherein the insight data structures are in-memory representations of medical treatment guideline positional statements for the application of medical treatments to patients having specified medical conditions.

14. The computer program product of claim 11, wherein the modification is one of a change to an existing positional statement or existing guideline, the addition of a new positional statement or new guideline, or the deletion of an existing positional statement or existing guideline, and wherein updating the affected insight data structure comprises at least one of modifying a parameter of the affected insight data structure based on the modification, adding a new insight data structure, or deleting the affected insight data structure.

15. The computer program product of claim 11, wherein the computer readable program further causes the computing device to determine an insight data structure affected by the modification at least by:
determining a scope of change of the modification of the positional statement or guideline; and
determining an adjustment to be applied to an insight data structure mapped to the modified positional statement or guideline based on the scope of change.

16. The computer program product of claim 15, wherein the computer readable program further causes the computing device to update the affected insight data structure at least by applying the determined adjustment to the insight data structure.

17. The computer program product of claim 12, wherein the cognitive operation comprises:
analyzing a patient electronic medical record based on the updated set of insight data structures; and
outputting a medical treatment recommendation for treating a patient corresponding to the patient electronic medical record.

18. The computer program product of claim 11, wherein each insight data structure has, in a mapping data structure, an associated unique identifier that links the insight data structure to a portion of a corresponding positional statement or guideline in the content of the corpus, and wherein the computer readable program further causes the computing device to determine an insight data structure affected by the modification to the positional statement or guideline at least by performing a lookup operation in the mapping data structure based on a unique identifier associated with the modified positional statement or guideline.

19. The computer program product of claim 12, wherein the cognitive operation is the generation and output of a medical treatment recommendation for treating a medical condition of a patient by evaluating a patient electronic medical record based on the updated insight data structure to determine if a medical treatment associated with the updated insight data structure applies to the medical condition of the patient and the patient's characteristics match requirements set forth in the updated insight data structure.

20. An apparatus comprising:
a processor; and
a memory coupled to the processor, wherein the memory comprises instructions which, when executed by the processor, cause the processor to implement a cognitive system which operates to:
ingest a corpus of content, wherein the corpus of content comprises a plurality of guideline documents having one or more positional statements;
generate a set of insight data structures based on the ingested corpus, wherein the set of insight data structures are mapped to corresponding positional statements or guidelines in the content of the corpus from which the insight data structures were generated;
receive a modification to a positional statement or guideline in the corpus;
determine an insight data structure affected by the modification to the positional statement or guideline based on the set of insight data structures and the mapping to corresponding positional statements or guidelines;
update the affected insight data structure, without re-ingesting the entire corpus, to generate an updated set of insight data structures; and
perform a cognitive operation based on the updated set of insight data structures.
